(19) United States
(12) Patent Application Publication
(10) Pub. No.: US 2007/0145047 A1
(43) Pub. Date: Jun. 28, 2007

(54) Thermal processor

(76) Inventors: Ronald G. Mickey, Tampa, FL (US); Christopher O. Norman, Olathe, KS (US); Bruce M. Gould, Corona Del Mar, CA (US)

Correspondence Address: FULBRIGHT AND JAWORSKI LLP, 555 S. FLOWER STREET, 41ST FLOOR, LOS ANGELES, CA, 90071, US

(21) Appl. No.: 11/318,349

(22) Filed: Dec. 22, 2005

(51) Int. Cl. H05B 6/78

(52) U.S. Cl. 219/752

(57) ABSTRACT

Thermal processing apparatus and a method for the defrosting of meat are disclosed. A vessel includes an opening, and a rotation assembly is adapted to rotate the vessel such that the opening is disposed on the axis of rotation. The vessel preferably comprises electrically conductive walls. An RF source is adapted to direct electromagnetic energy into the vessel through the opening. Preferably, the electromagnetic energy is in the microwave spectrum. The apparatus includes a waveguide which couples electromagnetic energy from the RF source to the opening in the vessel. A rotary coupling is used to couple electromagnetic energy from the RF source to the opening in the vessel. The process includes tumbling and radiating the product with microwave energy to bring the product from below the latent heat stage to fully defrosted.

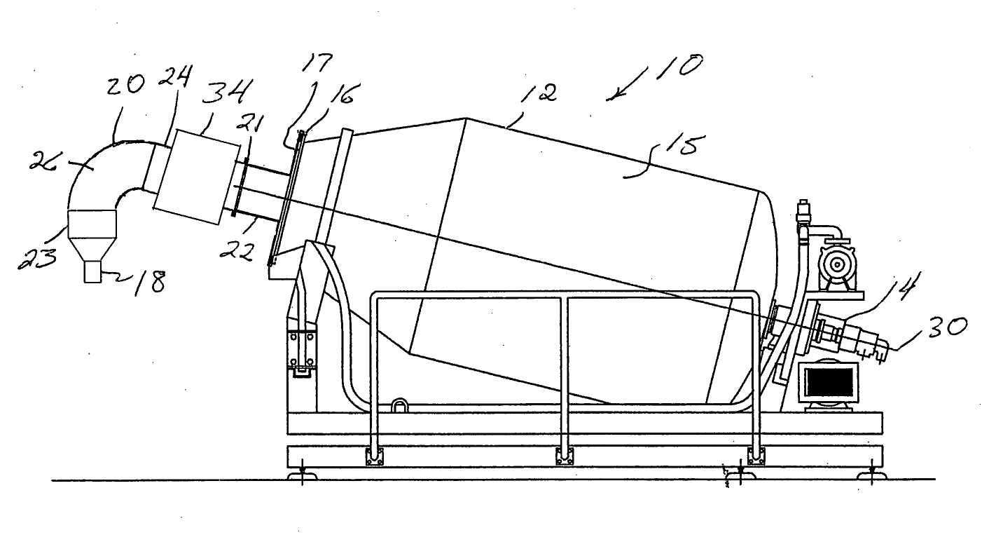

### BACKGROUND OF THE INVENTION

The field of the present invention is thermal processing and more specifically the heating of products.

Currently one of three methods are commonly used to defrost frozen meat. In one method, referred to as “air tempering”, the frozen meat is placed in a temperature-controlled room to thaw, a process which generally takes approximately 3-5 days. During the thawing process, valuable protein, amounting to 2% or more of the total protein content, is lost through drippage.

In another method, referred to as “water tempering”, the frozen meat is placed into a vat containing chilled water. A continuous flow of tempering water is passed through the vat for a period of approximately 8-12 hours to thaw the meat. During this process, valuable protein leeches out into the tempering water, causing the meat to turn from a desirable bright red coloration to an unwanted gray color. The change in color and protein content leads directly to a loss in market value for the defrosted meat.

In a third method, the frozen meat is placed into large rotating vessels into which low pressure steam is introduced. This method is generally capable of thawing the meat over a period of 8-12 hours. However, even with this third method, the problems previously mentioned persist—valuable protein and the red coloration are compromised.

Standard industrial microwave ovens might also be used to temper frozen meat, raising the temperature of the meat from 0° F. to above 32° F. in a very short period of time. Such ovens, however, cannot break through the latent heat stage at ˜28° F. without burning or cooking the surface of the meat. Because of this problem with microwave thawing, air, water, or steam tempering have heretofore been the preferred methods of defrosting frozen meat.

Microwave ovens are also used in other contexts for heating food products. Such ovens typically operate to avoid standing waves channeling through the food product by moving the food product on a horizontal plan relative to the microwave generator. The relative motion may be rotational, as in home microwave ovens, or linear, as is processing systems.

### SUMMARY OF THE INVENTION

The present invention is directed to apparatus and method for thermal processing.

The processing apparatus includes a vessel with an interior and a vessel wall opaque to RF radiation. A rotation assembly can rotate the vessel about an axis at a substantial angle to the vertical. Additionally, a source of RF radiation is in communication with the interior of the vessel.

The method of processing food includes placing meat in a vessel capable of full containment of microwave radiation. The meat is then tumbled by rotating the vessel about an axis at a substantial angle from the vertical with microwave energy introduced to the tumbling meat.

Accordingly, it is an object of the present invention to provide improved thermal processing apparatus and methods of processing meat. Other objects and advantages will appear hereinafter.

### BRIEF DESCRIPTION OF THE DRAWINGS

The Figure illustrates a side view of a thermal processor.

### DETAILED DESCRIPTION OF THE PREFERRED EMBODIMENTS

Turning in detail to the Figure, a thermal processor 10 is illustrated which is adapted to defrost frozen meat. The thermal processor 10, however, has the capacity to receive many other products, and the capability to provide defrosting, preheating, non-shear cooking, sterilizing or pasteurizing of food products and other products. The thermal processor 10 includes a vessel 12 and a rotation assembly and mount 14. Such vessels and the associated rotation assemblies are described in U.S. Pat. Nos. 4,657,771 and 4,517,888, the disclosures of which are incorporated herein by reference. The interior configuration of the vessel 12, i.e. the arrangement of the flights, vanes, baffles, shelves, and the like, is a matter of design choice based upon the particular intended use of the processor as more fully articulated in the incorporated patents.

The vessel 12 includes an interior and a vessel wall. The vessel wall includes a chamber 15 which is conveniently of circular cross section throughout its length. One end of the chamber 15 is closed and the other end includes a circular-shaped opening 16 through which products, such as meat, may be loaded into the vessel cavity. The vessel wall further includes a circular cover 17 which is positionable securely on the circular-shaped opening 16. The vessel wall, including the chamber 15 and the cover 17, is electrically conductive or includes a layer of electrical conductivity to form an opaque barrier to RF radiation.

A source of RF radiation includes an RF generator 18 coupled to a waveguide 20. The waveguide 20 is in turn coupled with an opening 21 through the vessel wall at the cover 17. The opening 21 is defined in this embodiment by a cylindrical pathway through a cylinder 22 fixed to the cover 17. The waveguide 20 directs electromagnetic energy emitted by the RF generator 18 through the cylinder 22 and into the vessel interior. In order to facilitate introduction of electromagnetic energy into the vessel interior, and to accommodate readily available RF sources and the circular shape of the opening 21, a first section 23 of the waveguide 20 is rectangular (or even square) in cross section, a last section 24 is round in cross section, and a middle section 26 between the first section 23 and the last section 24 is a mode converter which transitions from a rectangular cross section to a circular cross section. The opening 16, the opening 21 and the last section 24 of the waveguide 20 are coaxial with the vessel's axis of rotation 30.

The cover 17 at the opening 21 defined by the cylinder 22 is rotationally coupled with the last section 24 of the waveguide 20 at the rotary coupling 34. The rotary coupling 34 provides electrical continuity between the cover 32 and the last section 24 of the waveguide 20 to prevent leakage of the electromagnetic energy and arcing while permitting the vessel 12 and cover 17 to rotate with respect to the waveguide 20. For example, a metallized choke or gasket may be employed at the rotary coupling 34 to maintain electrical continuity between the cover 17 and the waveguide 20. Likewise, all other junctions at points between the RF generator 18 and the vessel 12 can be similarly constructed to maintain electrical continuity.

The vessel's axis of rotation 30 is inclined at approximately a 76° angle from the vertical, although any angle sufficient to give a tumbling action to the product in the vessel interior, including horizontal, will suffice. The employment of a shallow angle to the horizontal is understood to give some functionality to the loading, unloading and capacity to the equipment. The presence of tumbling will occur at a greater angle to the horizontal than shown. Rotation about a vertical or near vertical axis will not, however.

The RF generator 18 is preferably a microwave transmitter which emits electromagnetic energy in the 75 kW to 100 kW range within the spectrum of 890 MHz to 920 MHz. The energy output and spectrum may be adjusted as is appropriate to optimize absorption of the energy by the subject product within the vessel 12 and minimize feedback into the waveguide from the vessel 12.

During operation of the thermal processor 10, the product to be thermally processed is inserted into the vessel cavity after removal of the cover 17. The cover is then replaced and the vessel 12 is rotated. While the vessel 12 is rotating, the RF generator 18 is activated and the desired power level and spectrum of electromagnetic energy is directed into the vessel 12. The rotation and irradiation continue until the desired end point of the process is attained.

One example of a beneficial use of the thermal processor 10 described above is to process frozen meat, such as meat blocks, pork bellies, ham muscles, and the like. Such meats may be completely defrosted to 33° F. in approximately two hours without significant loss of valuable protein or red coloration. Frozen ham muscles may be broken up during the defrosting and tumbling process, resulting in substantial separation into individual muscles. During this process, ice crystals form prior to completion of defrosting. These ice crystals act as tenderizers by puncturing the meat and connective tissue, thus improving the quality of the defrosted meat product. After the meat has been completely defrosted, it may be removed from the vessel for pickling or marinating, or alternatively, the pickle or marinade may be added directly into the vessel for additional processing therein. Alternative processes are, of course, contemplated as well.

Thus, a thermal processing apparatus and method of processing meat are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A thermal processor comprising
a vessel including an interior and a vessel wall opaque to RF radiation;
a rotation assembly adapted to rotate the vessel about an axis at a substantial angle to the vertical; and
a source of the RF radiation in communication with the interior of the vessel.

2. The processor of claim 1, the vessel including an opening through the vessel wall to the interior, the opening being disposed on the axis of rotation of the vessel.

3. The processor of claim 2, the source of the RF radiation including an RF generator and a waveguide adapted to transmit RF radiation from the RF generator to the opening through the vessel wall.

4. The processor of claim 3, the waveguide including a mode converter.

5. The processor of claim 3, the source of the RF radiation further including a rotary coupling adapted to transmit RF radiation from the RF generator through the opening in the vessel.

6. The processor of claim 2, the opening being closed to RF radiation by the source of RF radiation, giving the interior of the vessel full containment of the RF radiation.

7. The processor of claim 1, the RF radiation being in a microwave spectrum.

8. The processor of claim 1, the axis of rotation of the vessel being at an angle of about 76° from the vertical.

9. The processor of claim 1, the wall of the vessel including a chamber of circular cross section with a closed end and a circular cover on an otherwise open end, the cover having an opening therethrough to the interior, the opening being disposed on the axis of rotation of the vessel.

10. The processor of claim 9, the cover being openable for loading and unloading, the opening therethrough being closed to RF radiation by the source of RF radiation, giving the interior of the vessel full containment of the RF radiation with the cover in place on the chamber.

11. The processor of claim 10, the RF radiation being in a microwave spectrum.

12. The processor of claim 11, the axis of rotation of the vessel being at an angle of about 76° from the vertical.

13. A method of processing meat, comprising
placing the meat in a vessel capable of full containment of microwave radiation;
tumbling the meat in the vessel including rotation of the vessel about an axis at a substantial angle from the vertical;
directing microwave energy to the tumbling meat.

14. The method of claim 13, tumbling the meat being about an axis at an angle of at least about 76° from the vertical.

15. The method of claim 13, placing the meat being with the meat at a temperature below the latent heat stage, tumbling the meat and directing microwave energy being until the meat is fully defrosted.
